(19) United States
(12) Patent Application Publication
(10) Pub. No.: US 2018/0301289 A1
(43) Pub. Date: Oct. 18, 2018

(54) LITHIUM ION CAPACITOR AND FORMATION METHOD THEREFOR

(71) Applicant: SHANGHAI AOWEI TECHNOLOGY DEVELOPMENT CO. LTD., Shanghai (CN)

(72) Inventors: Mingxia WU, Shanghai (CN); Zhongxun AN, Shanghai (CN); Tingli HUANG, Shanghai (CN); Liangliang YAN, Shanghai (CN); Lingling FAN, Shanghai (CN)

(21) Appl. No.: 15/768,890

(22) PCT Filed: Feb. 25, 2016
(86) PCT No.: PCT/CN2016/074522

§ 371 Date: Apr. 17, 2018

(30) Foreign Application Priority Data
Dec. 16, 2015 (CN) 201510947373.4

(51) Int. Cl. H01G 11/06; H01G 11/32; H01G 11/50; H01G 11/46; H01G 11/86; H01G 11/66

(52) U.S. Cl. CPC H01G 11/06; H01G 11/32; H01G 11/66; H01G 11/46; H01G 11/86; H01G 11/50

(57) ABSTRACT

It relates to a lithium ion capacitor and a formation method thereof. A positive electrode of the capacitor comprises porous carbon and lithium-intercalated metal oxide, and a negative electrode thereof is carbon difficult to graphitize. The metal lithium electrode and a cell are arranged in a face-to-face manner and separated by separator. A current collector adopts a porous current collector. During formation, the lithium-intercalated oxide in the positive electrode is used as a lithium source to intercalate lithium into the negative electrode, and a third electrode lithium plate is used for supplementing lithium ions to the metal oxide in a lithium-deintercalated state of the positive electrode.

### TECHNICAL FIELD

The present invention relates to a lithium ion capacitor and a formation method thereof.

### BACKGROUND ART

In recent years, lithium-ion secondary batteries have been greatly developed. A negative electrode of this battery generally uses a carbon material such as graphite, and a positive electrode thereof uses a lithium-containing metal oxide such as lithium cobalt oxide or lithium manganate. After the battery is assembled, the positive electrode provides lithium ions to the negative electrode during charging, and the lithium ions in the negative electrode return to the positive electrode during discharging. Therefore, it is called “rocking chair battery”. However, the cycle life of the lithium-ion secondary battery is still restricted because the negative electrode material tends to deform structurally during deintercalation of lithium. Therefore, in recent years, the research on a system in which the lithium-ion secondary battery and a supercapacitor are combined together has become a new hot spot.

At present, there are two ways to combine the two types of energy storage systems: the supercapacitor and the lithium-ion secondary battery: the first way is “externally combined”, i.e., cells of the supercapacitor and the lithium-ion secondary battery are combined into an energy storage device or system through a power management system; the second way is “internally combined”, i.e., the supercapacitor and the lithium-ion secondary battery are organically combined in one cell. The “internally combined” type power supply system has the advantages of high power, light weight, small size and low cost, can ensure the consistency of the cells and reduce the complexity of the management system, and thus has become the focus of today's research.

There is a lithium-ion capacitor whose positive electrode has both a lithium-ion energy storage function and a double electrode layer energy storage function and whose negative electrode serves for lithium-ion energy storage. This system has a higher voltage and can achieve high power. The positive electrode of this system has a double electrode layer energy storage function and a lithium-ion chemical energy storage function, and therefore the specific energy can be improved at the same time. Therefore, this system is an ideal system. However, because the positive electrode has different energy storage ways, and the potentials of the stored energy cannot be matched exactly, how to uniformly pre-doping is a difficult problem. In the pre-doping methods currently used in Japan and South Korea, holes are formed in positive and negative current collectors, such that lithium plates at both ends of the cell serve for pre-doping as a lithium source. In this method, the lithium ions released by the lithium plates can pass through the holes in the surfaces of the current collectors to reach the surface of the negative electrode to complete the pre-doping. However, in order to ensure the mechanical strength and electrical conductivity of the current collector, this method requires a porous current collector (the current collector is expensive, and at present, no manufacturer in China can mass-produce it). The actual passing rate of the lithium ions is lower and the pre-doping cannot be completed quickly due to the impossibility of excessive holes in the porous current collector itself. Meanwhile, the uniformity of active substances in the various parts of the negative electrode plate is the key to the consistency of cells of the capacitor and determines whether a plurality of capacitors can be connected in series into groups in future.

Existing lithium-ion capacitor technologies are generally divided into two types: the use of a porous current collector and the use of a non-porous current collector. The formation process of the former is relatively simple, but the process is very complex and the cost of the current collector is high. The latter is generally pre-doped with a third electrode lithium source, but it is difficult to achieve a uniform effect, thereby adversely affecting the cycling of the lithium-ion capacitor. For example, a patent “Lithium Pre-intercalation Method for Negative Electrode of Lithium Ion Capacitor” (CN201510522888) filed by Institute of Electrical Engineering, Chinese Academy of Sciences discloses a lithium pre-intercalation method for a negative electrode of a lithium ion capacitor negative. In this method, the lithium pre-intercalation process is to place a metal lithium electrode and a cell in a face-to-face manner and separate them by a diaphragm, a bias voltage is applied between the metal lithium electrode and the negative electrode, and the negative electrode is lithium-intercalated in a constant voltage discharging manner.

### SUMMARY OF THE INVENTION

A main objective of the present invention is to solve the defect that the uniform effect of pre-doping in the prior art is not good.

In order to fulfill objective said before, a lithium ion capacitor was provided in this invention. A positive electrode of the capacitor comprises porous carbon and lithium-intercalated metal oxide, and a negative electrode thereof is carbon difficult to graphitize. The metal lithium electrode and a cell are arranged in a face-to-face manner and separated by separator. A porous current collector is used as the current collector.

The lithium-intercalated metal oxide in the positive electrode includes one of lithium cobalt oxide, nickel cobalt lithium manganate, lithium manganite, lithium manganate, lithium permanganate, nickel cobalt lithium aluminate, lithium nickelate, lithium iron phosphate, and lithium vanadium phosphate.

An electrode plate size is 43×30 mm, a positive electrode surface density is 160 g/m², and a negative electrode surface density is 85 g/m². There are 15 positive electrode plates and 16 negative electrode plates. A cellulose separator is adopted for laminating. A lithium plate is placed at two sides of the cell respectively.

The present invention further comprises a formation method of a lithium ion capacitor, which is characterized by comprising the following steps:

Step 1, lithium-intercalating the negative electrode by taking the lithium-intercalated oxide in the positive electrode as a lithium source; and

Step 2, supplementing, by a third electrode lithium plate, lithium ions to the metal oxide in a lithium-deintercalated state of the positive electrode.

The step 1 solves the problem that the lithium ions cannot be uniformly and vertically doped to the negative electrode, and enables the negative electrode to form a well-uniform SEI film while keeping a carbon material of the negative electrode in a uniform lithium-intercalated state. The step 2 supplements the lithium required for the recovery of the lithium-deintercalated state of the positive electrode. At the same time, the two steps are conducive to balancing and matching the potentials of the lithium-containing oxide and the active carbon of the positive electrode.

Further, the step 1 is divided into two substeps:

in the first substep, the current is 0.01 C to 0.05 C, and the charging time is 2 to 10 h;

In the second substep, the current is 0.2 C to 1 C.

The current in the step 2 is 0.2 C to 1 C.

In the step 1, the total charging capacity is 20%-50% of the total capacity of the negative electrode.

The charging capacity in the step 2 is equal to the charging capacity in the step 1.

Compared with the prior art, the present invention has the advantages that the lithium ion capacitor can be formed (pre-doped) in two steps so as to make the doping of the negative electrode more stable, efficient and uniform, the cycle life of the capacitor can be prolonged, the consistency of the capacitor can be improved, and the assembling of a module and a system can be facilitated.

### BRIEF DESCRIPTION OF THE DRAWINGS

FIG. 1 is a schematic structural drawing of a lithium ion capacitor in an embodiment;

FIG. 2 illustrates Embodiments 1 to 5;

FIG. 3 illustrates Embodiments 6 to 10, continued on FIG. 2;

FIG. 4 illustrates Embodiments 11 to 12, continued on FIG. 3.

### DETAILED DESCRIPTION OF THE PREFERRED EMBODIMENTS

The present invention is further described below with reference to the embodiments and the accompanying drawings. The embodiments and the accompanying drawings are only used for illustration and are not intended to limit the protection scope of the present invention.

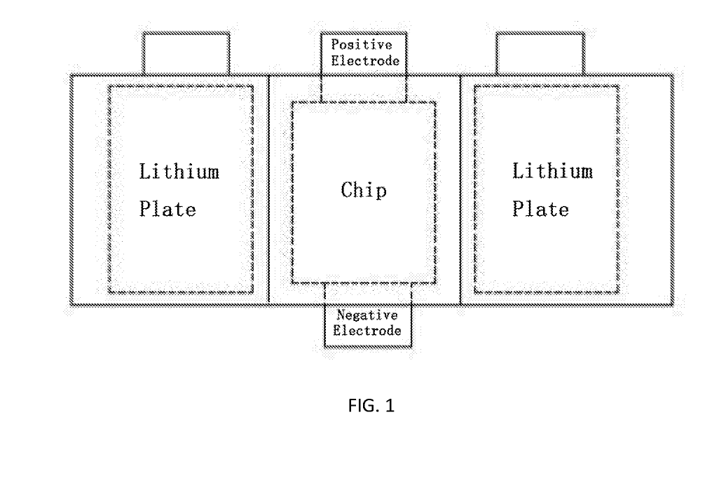

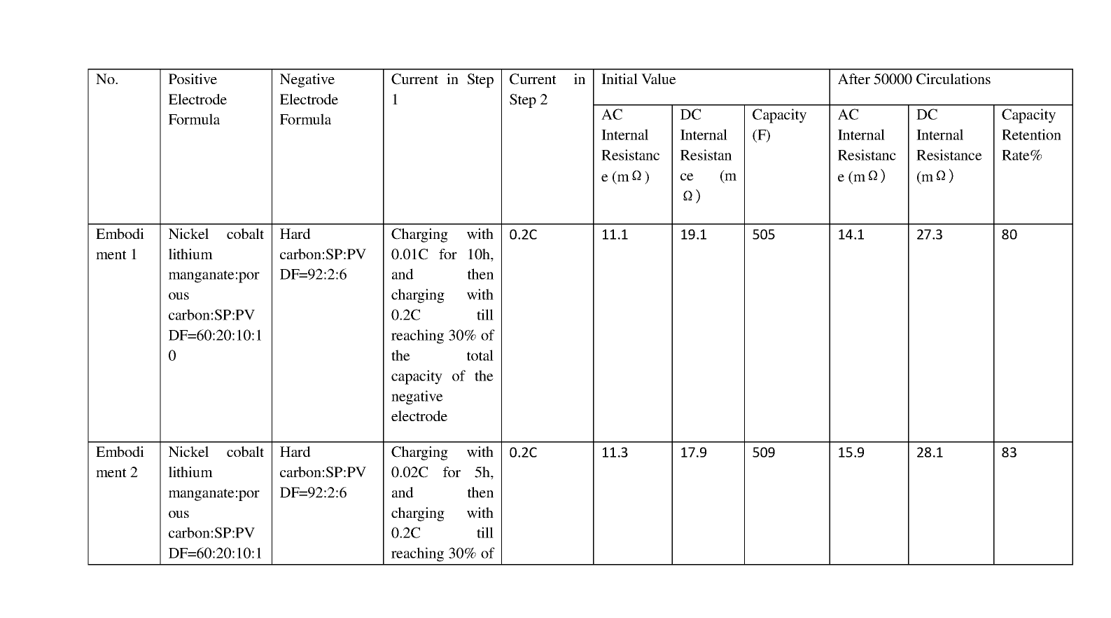

A lithium ion capacitor in the present embodiment has a structure as follows. As shown in FIG. 1, a positive electrode of the capacitor comprises porous carbon and lithium-intercalated metal oxide, and a negative electrode thereof is carbon difficult to graphitize. The metal lithium electrode and a cell are arranged in a face-to-face manner and separated by separator. A porous current collector is used as the current collector.

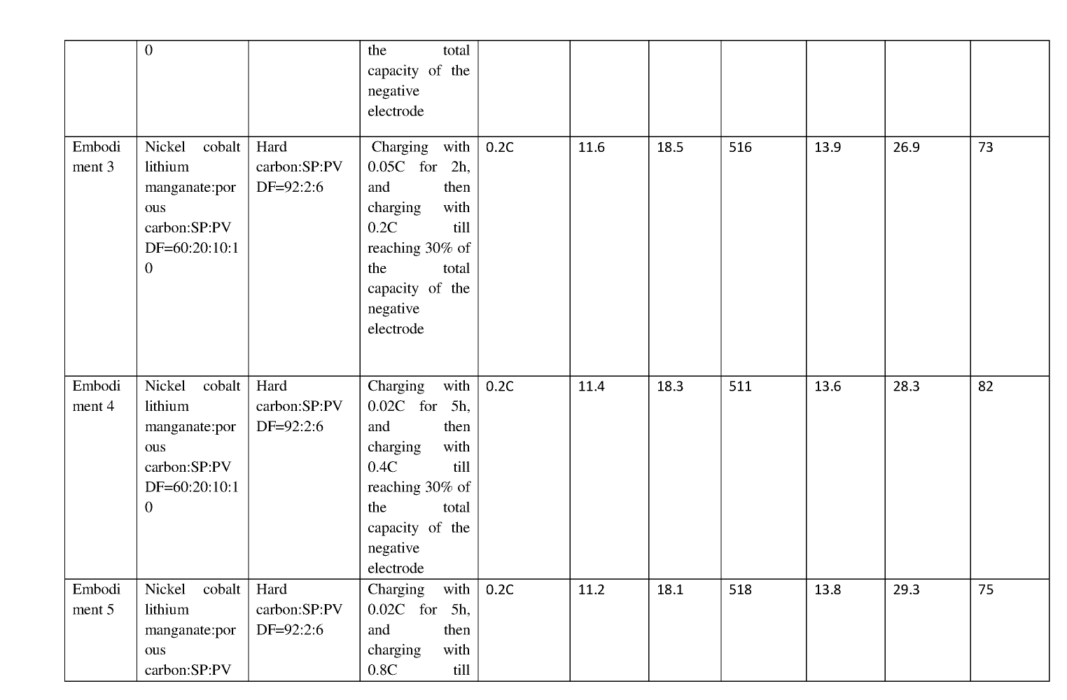

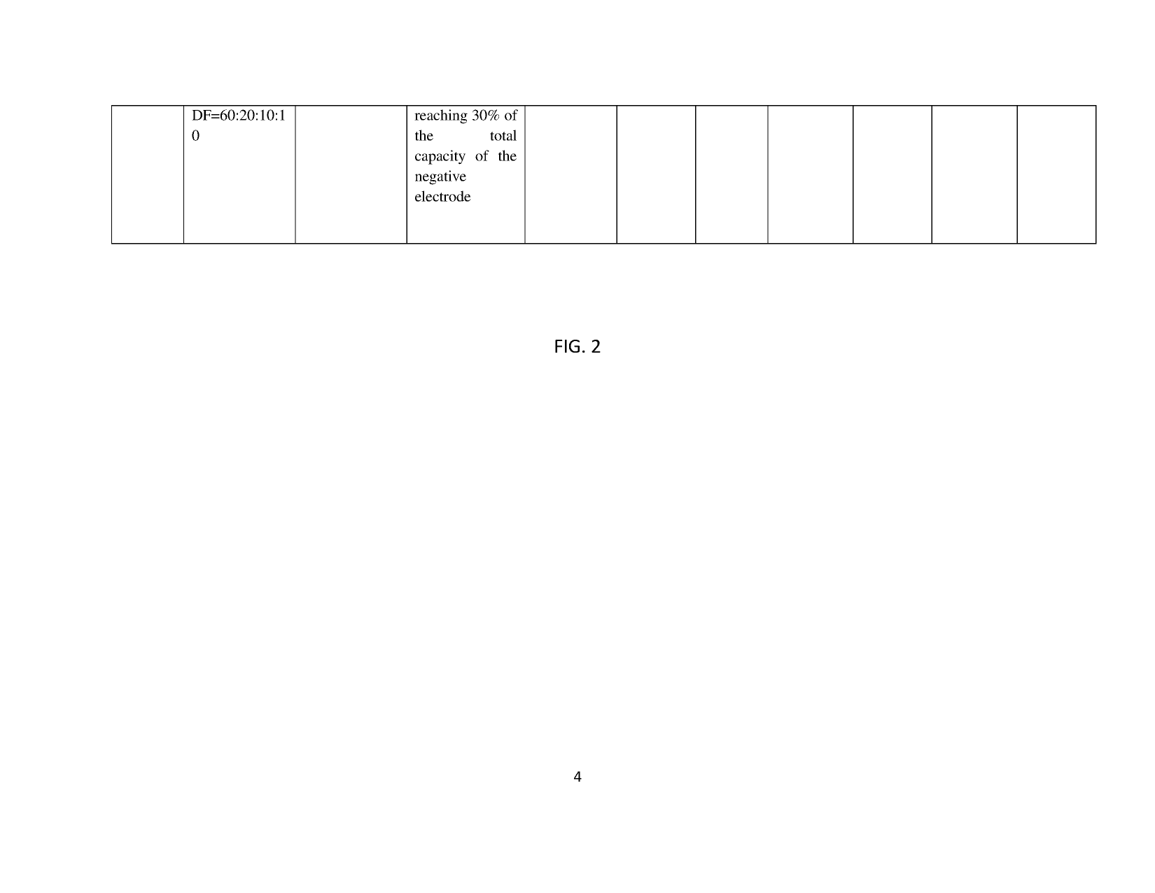

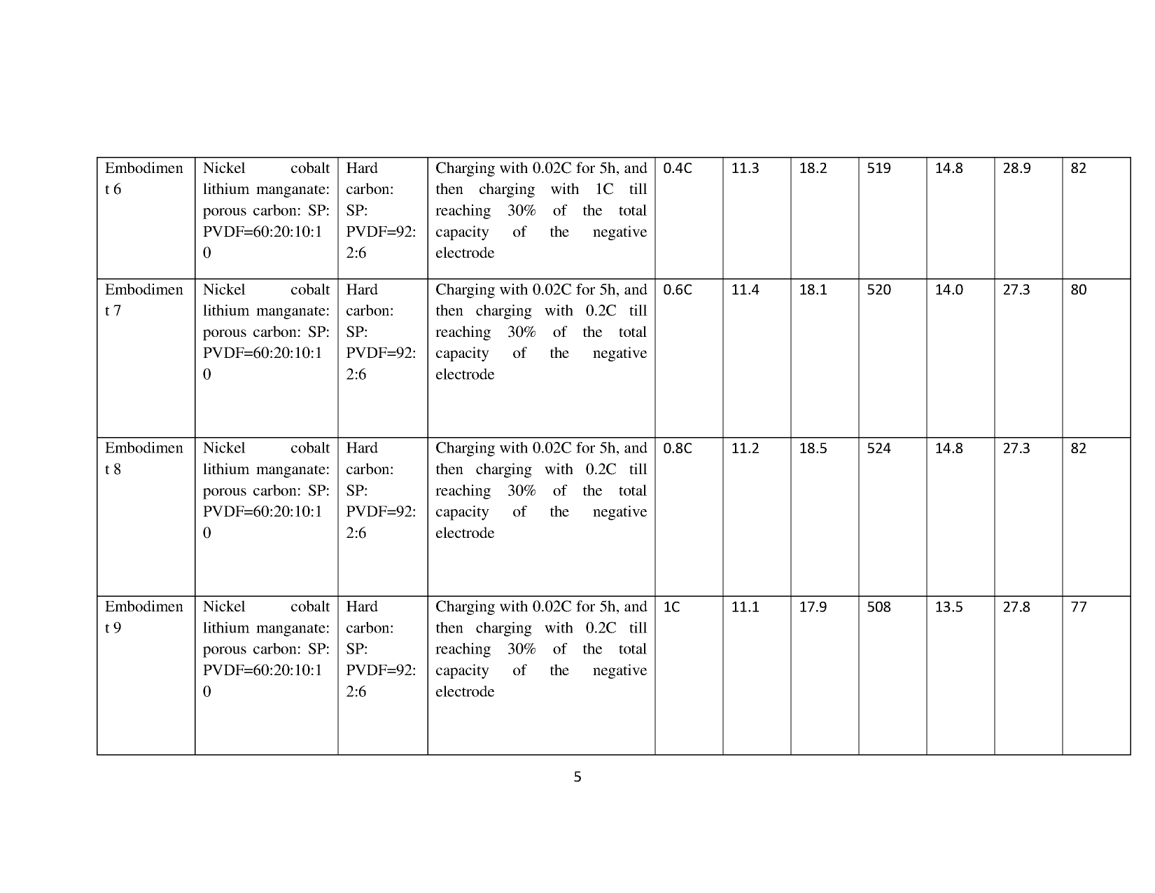

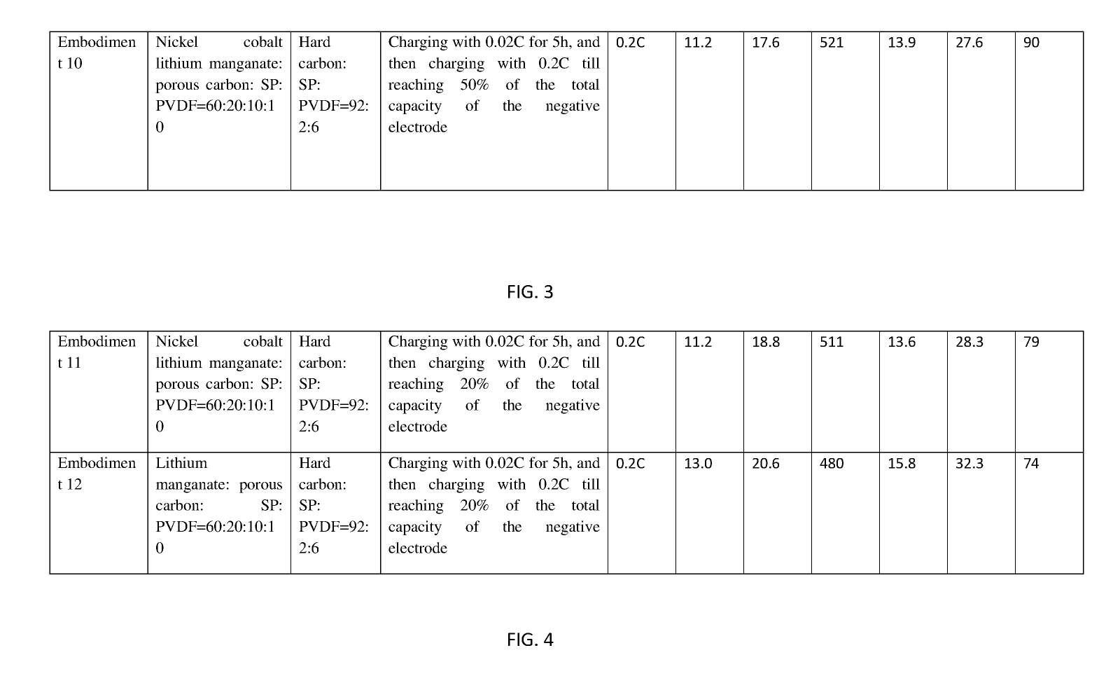

In a preparation process of the lithium ion capacitor, a positive electrode formula and a negative electrode formula are as shown in FIGS. 2 to 4. An electrode plate size is 43×30 mm, a positive electrode surface density is 160 g/m², and a negative electrode surface density is 85 g/m². There are 15 positive electrode plates and 16 negative electrode plates. A cellulose separator is adopted for laminating. A lithium plate is placed at two sides of the cell respectively.

The lithium ion capacitor is formed according to the following steps: 1, lithium-intercalating the negative electrode by taking the lithium-intercalated oxide in the positive electrode as a lithium source, and charging a middle cell with a low current for a certain time first, and then with a high current till reaching 30% of the total capacity of the negative electrode; and 2, supplementing, by a third electrode lithium plate, lithium ions to the metal oxide in a lithium-deintercalated state of the positive electrode, wherein a charging capacity is equal to the charging capacity in the step 1. The formation current and the charging time are as shown in FIGS. 2 to 4. At the end of charging, the lithium plates at two sides are cut off and edges are then sealed to obtain the formed lithium ion capacitor which can be charged and discharged. The initial capacity and the internal resistance as well as the capacity and the internal resistance after 50000 cycles are tested.

What is claimed is:

1. A lithium ion capacitor, wherein a positive electrode of the capacitor comprises porous carbon and lithium-intercalated metal oxide, and a negative electrode thereof is carbon difficult to graphitize; the metal lithium electrode and a cell are arranged in a face-to-face manner and separated by separator; a porous current collector is used as the current collector.

2. The lithium ion capacitor according to claim 1, wherein the lithium-intercalated metal oxide in the positive electrode includes one of lithium cobalt oxide, nickel cobalt lithium manganate, lithium manganite, lithium manganate, lithium permanganate, nickel cobalt lithium aluminate, lithium nickelate, lithium iron phosphate, and lithium vanadium phosphate.

3. The lithium ion capacitor according to claim 1, wherein an electrode plate size is 43×30 mm, a positive electrode surface density is 160 g/m², and a negative electrode surface density is 85 g/m²; there are 15 positive electrode plates and 16 negative electrode plates; a cellulose separator is adopted for laminating; a lithium plate is placed at two sides of the cell respectively.

4. A formation method for the lithium ion capacitor according to claim 1, comprising the following steps:
step 1, lithium-intercalating the negative electrode by taking the lithium-intercalated oxide in the positive electrode as a lithium source; and
step 2, supplementing, by a third electrode lithium plate, lithium ions to the metal oxide in a lithium-deintercalated state of the positive electrode.

5. The formation method for the lithium ion capacitor according to claim 2, wherein the step 1 is divided into two sub-steps:
in the first sub-step, the current is 0.01 C to 0.05 C, and the charging time is 2 to 10 h;
in the second sub-step, the current is 0.2 C to 1 C.

6. The formation method for the lithium ion capacitor according to claim 2, the current in the step 2 is 0.2 C to 1 C.

7. The formation method for the lithium ion capacitor according to claim 2, in the step 1, the total charging capacity is 20%-50% of the total capacity of the negative electrode.

8. The formation method for the lithium ion capacitor according to claim 2, the charging capacity in the step 2 is equal to the charging capacity in the step 1.
